(19) United States
(12) Patent Application Publication
(10) Pub. No.: US 2012/0058353 A1
(43) Pub. Date: Mar. 8, 2012

(54) Al ALLOY REFLECTIVE ELECTRODE FILM FOR FORMING ANODE LAYER FOR TOP-EMITTING ORGANIC EL ELEMENT

(76) Inventors: Shozo Komiyama, Sanda-shi (JP); Gou Yamaguchi, Sanda-shi (JP)

(21) Appl. No.: 13/319,835

(22) PCT Filed: May 14, 2010
(86) PCT No.: PCT/JP2010/003272

§ 371 Date: Nov. 10, 2011

(30) Foreign Application Priority Data
May 14, 2009 (JP) 2009-117184
Apr. 28, 2010 (JP) 2010-102902

(51) Int. Cl. B32B 15/04

(52) U.S. Cl. 428/457

(57) ABSTRACT

An Al alloy reflective electrode film in the anode layer of a top emission type organic EL element is provided. The Al alloy repeller has high reflectivity, high electric conductivity, a low average surface roughness, and low contact resistance. The Al alloy reflective electrode film is made of an Al alloy consisting of 0.5 to 15% by mass of Mg, a total amount of 0.5 to 10% by mass of one or more elements selected from the group consisting of La, Ce, Pr, Nd, and Eu, and the remainder composed of Al and inevitable impurities, or consisting of 0.5 to 15% by mass of Mg, 0.5 to 10% by mass of Ce, a total amount of 2 to 9% by mass of one or two elements selected from the group consisting of Ni and Co, and the remainder composed of Al and inevitable impurities. Because of these configuration, the reflective electrode film having high reflectivity, high electric conductivity, a low average surface roughness, and low contact resistance with the hole injection film, such as ITO and AZO, is formed.

### TECHNICAL FIELD

The present invention relates to an Al alloy reflective electrode film in an anode layer of a top emission type organic EL element.

Priority is claimed on Japanese Patent Applications No. 2009-117184, filed May 14, 2009, and No. 2010-102905, filed Apr. 28, 2010, the contents of which are incorporated herein by reference.

### BACKGROUND ART

An organic EL element is a light-emitting element, and its mechanism of action will be described as follows. When a voltage is applied between an anode and a cathode formed on both surfaces of an organic EL film, holes and electrons are injected to the organic EL film from the anode and the cathode, respectively. Then, the injected holes and electrons bond with each other in an organic EL light-emitting layer. When a light-emitting material excited by energy that is generated by the bonding returns to a ground state from the excited state, light is emitted. Organic EL displays with the organic EL elements as pixels are in practical use as a display apparatus for mobile devices, such as mobile phones. Since the organic EL display uses the organic EL element that emits light by itself, the organic EL display does not need a back light, such as the liquid crystal display. Furthermore, the organic EL display also has characteristics, such as a thin thickness, a light weight, low power consumption, and a high contrast ratio.

The method of retrieving light from the organic EL element includes a bottom emission type, in which light is retrieved from the side of a transparent substrate, such as glass, and a top emission type, in which light is retrieved from the opposite side of the substrate. The layer structure of the top emission type organic EL element in which an anode layer, an organic EL layer, an electron injection layer, and a cathode layer are laminated on the surface of a glass substrate sequentially from the substrate side in the order is known. The anode layer in the structure described above has a reflective electrode film and a hole injection film. The organic EL layer in the structure described above has a hole injection layer, a hole transporting layer, and an organic light-emitting layer. In addition, the cathode layer has light permeability.

With regard to the reflective electrode film, which is a constituent of the anode layer in the top emission type organic EL element, using reflective electrode films made of highly-pure Al or an Al alloy containing 5 atom% or less of one or more elements selected from the group consisting Nd, Ta, Nb, Mo, W, Ti, Si, B, and Ni, has been proposed in the past.

### PATENT LITERATURE

PTL 1: Japanese Unexamined Patent Application, First Publication No. 2005-56848

### DISCLOSURE OF INVENTION

### Problems to be Solved by the Present Invention

The organic EL element is highly useful due to its thin thickness, light weight, low power consumption, high contrast ratio, and the like. However, there is demand for extending the lifetime of the organic EL element in order to improve its practicality further. One of the causes for deterioration of the organic EL element is the occurrence of dark spots induced by recesses and protrusions on the foundation film of the organic EL layer. To be more specific, the electric field is increased, and the current is concentrated at the protrusion portion of the organic EL layer because of two reasons described below. One reason is that the thickness of the organic EL layer is extremely thin, about 10 nm to 200 nm. Another reason is that there are large recesses and protrusions on the surface of the anode layer, which is the foundation layer of the organic EL layer. The concentration of the electrical power at the protrusion portion accelerates deterioration of the organic EL layer and, consequently, reduces the light-emitting brightness of the light-emitting material such that, finally, the light-emitting material ceases to emit light.

The anode layer of the top emission type organic EL element is generally composed of the reflective electrode film and the hole injection film (for example, ITO and AZO). Since the hole injection film is extremely thin, the surface shape of the hole injection film is formed using the surface shape of the reflective electrode film as a mold. Therefore, it is necessary to reduce the surface roughness of the reflective electrode film and the average surface roughness of the anode layer in order to extend the lifetime of the organic EL element.

PLT 1 describes that a high reflectivity and low resistance top emission type organic EL element can be obtained by using a reflective electrode film made of a material of highly-pure Al or an Al alloy in a specific component composition. However, the occurrence of dark spots in the organic EL element cannot be sufficiently reduced based on the disclosure of PLT 1, and, consequently, the organic EL element having the reflective electrode film based on PLT 1 has a problem in that the lifetime is short.

### Means for Solving the Problem

In order to solve the above problem, an Al alloy reflective electrode film in an anode layer of a top emission type EL element of the first aspect of the present invention has the configuration below. The Al alloy reflective electrode film of the first aspect of the present invention is an Al alloy reflective electrode film in an anode layer of a top emission type EL element having a component composition consisting of: 0.5 to 15% by mass of Mg; a total amount of 0.5 to 10% by mass of one or more elements selected from the group consisting La, Ce, Pr, Nd, and Eu; and a remainder composed of Al and inevitable impurities.

The Al alloy reflective electrode film of the second aspect of the present invention is an Al alloy reflective electrode film in an anode layer of a top emission type EL element having a component composition consisting of: 1 to 5% by mass of Mg; 1 to 3% by mass of Ce; and a remainder composed of Al and inevitable impurities.

The Al alloy reflective electrode film of the third aspect of the present invention is an Al alloy reflective electrode film in an anode layer of a top emission type EL element having a component composition consisting of: 0.5 to 15% by mass of Mg; 0.5 to 10% by mass of Ce; a total amount of 2 to 9% by mass of one or two elements selected from the group consisting of Ni and Co; and a remainder composed of Al and inevitable impurities.

The Al alloy reflective electrode film of the fourth aspect of the present invention is an Al alloy reflective electrode film in an anode layer of a top emission type EL element having a component composition consisting of: 0.5 to 15% by mass of Mg; 0.5 to 10% by mass of Ce; 4 to 15% by mass of Pd; and a remainder composed of Al and inevitable impurities.

### Effects of the Present Invention

According to the Al alloy reflective electrode film of the present invention, the average surface roughness of the anode layer in the top emission type organic EL element is reduced, and, furthermore, the contact resistance between the Al alloy reflective electrode film and the hole injection film, such as ITO, is also reduced. Thereby, occurrence of dark spots can be suppressed, and, consequently, the lifetime of the top emission type organic EL element having the repeller layer of the present invention can be extended. In addition, the Al alloy reflective electrode film provided by the present invention allows to maintain high reflectivity and electric conductivity of the reflective electrode film.

### Embodiments of the Present Invention

An Al alloy reflective electrode film in the anode layer of a top emission type organic EL element of the present invention will be explained below.

As a material for the Al alloy film of the present invention, a melted and cast Al alloy ingot can be used. Alternatively, an Al alloy, which is obtained by performing thermal plastic forming of a pressure-sintered body of an Al alloy powder, heat treatment for recrystallization, and machine working in order.

The component composition of the Al alloy composing the reflective electrode film of the present invention is explained below.

Mg forms a solid solution in Al, and suppresses crystal grain growth while the reflective electrode film is formed. Thereby, the average surface roughness of the film is reduced, and, furthermore, the contact resistance between the reflective electrode film and the hole injection film, such as ITO, is also reduced. However, when the content of Mg is less than 0.5% by mass, the effect of reducing the average surface roughness and the contact resistance is not sufficient. On the other hand, when the content of Mg exceeds 15% by mass, cracking becomes liable to occur in an Al alloy sputtering target used for the formation of the film, and it becomes difficult to form the film. Furthermore, the specific resistance of the obtained film itself is increased, and it becomes impossible to form a highly conductive reflective electrode film. For the above reasons, a preferable content of Mg ranges 0.5 to 15% by mass. A more preferable content of Mg ranges 1 to 5% by mass.

Any of the added components having one or more elements selected from the group consisting La, Ce, Pr, Nd, and Eu improves the corrosion resistance of the reflective electrode film. Therefore, by adding the above components, a high reflectivity of the reflective electrode film can be maintained for a long time. In addition, the added components having one or more elements selected from the group consisting La, Ce, Pr, Nd, and Eu form intermetallic compounds with Al at grain boundaries and suppresses the growth of crystal grains. As a result, the average roughness of the film is reduced further. Furthermore, addition of the components together with Mg also has an action of further reducing the contact resistance between the reflective electrode film and the hole injection film, such as ITO. However, when the total content of the added components having one or more elements selected from the group consisting La, Ce, Pr, Nd, and Eu is less than 0.5% by mass, the effect of improving the corrosion resistance, the effect of suppressing crystal grain growth, and the effect of reducing the contact resistance are insufficient. On the other hand, when the total content thereof exceeds 10% by mass, cracking becomes liable to occur in an Al alloy sputtering target used for the formation of the film, and therefore it becomes difficult to form the film. Furthermore, the reflectivity of the film is decreased, and, along with this, the specific resistance of the film itself tends to be increased, thereby impairing its high conductivity. For the above reasons, the total content of the added components having one or more elements selected from the group consisting La, Ce, Pr, Nd, and Eu is desirably 0.5 to 10% by mass.

Among La, Ce, Pr, Nd, and Eu, addition of Ce is particularly effective from the standpoint of further reducing the contact resistance between the reflective electrode film and the hole injection film, such as ITO. When the content of Mg is adjusted to 1 to 5% by mass, and, at the same time, 1 to 3% by mass of Ce is added, the contact resistance is significantly reduced, and extremely desirable characteristics as the reflective electrode film can be obtained.

Since Ce improves the corrosion resistance of the reflective electrode film as described above, a high reflectivity of the reflective electrode film can be maintained for a long time by adding Ce. In addition, since Ce forms an intermetallic compound with Al at crystal grain boundaries, crystal grain growth is suppressed by adding Ce. Thereby, the average surface roughness of the film is further reduced. Furthermore, adding Ce further reduces the contact resistance between the reflective electrode film and the hole injection film, such as ITO, by being coexisted with Mg in the film. When the content of Ce is less than 0.5% by mass, the above actions cannot be sufficiently exhibited. On the other hand, when the content of Ce exceeds 8% by mass, cracking becomes likely to occur in an Al alloy sputtering target used for the formation of the film, and it becomes difficult to form the film. When the content of Ce exceeds 10% by mass, the reflectivity of the film is significantly reduced. For the above reasons, the content of Ce is desirably 0.5 to 10% by mass. A more preferable content of Ce is 1 to 8% by mass.

One or two elements selected from the group consisting Ni and Co strongly bond with Al atoms in the reflective electrode film, suppressing the diffusion of Al. As a result, enlargement of crystal grains on the surface of the reflective electrode film in a constant temperature and humidity test is suppressed. Because of this, addition of one or two elements selected from the group consisting Ni and Co reduces the surface roughness of the film, and further improves the surface flatness retention capacity and flatness of the reflective electrode film. However, when the total content of one or two elements selected from the group consisting of Ni and Co is less than 2% by mass, the flatness retention capacity of the film surface is not sufficient. On the other hand, when the total content of one or two elements selected from the group consisting of Ni and Co exceeds 9% by mass, the reflectivity of the reflective electrode film is significantly reduced. For the above reasons, the total content of one or two elements selected from the group consisting of Ni and Co is desirably 2 to 9% by mass. A more preferable total content of one or both of Ni and Co is 3 to 8% by mass.

The effects of Pd are similar to those of Ni and Co, however, when the content of Pd is less than 4% by mass, the flatness retention capacity of the film surface is not sufficient. On the other hand, when the content of Pd exceeds 15% by mass, the reflectivity of the reflective electrode film is significantly reduced. For the above reasons, the content of Pd is desirably 4 to 15% by mass. A more preferable content of Pd is 5 to 14% by mass.

A target for sputtering using an Al alloy ingot obtained by casting melted Al alloy as a material is manufactured in the following manner. Firstly, Al is melted in a melting furnace, and at least one element selected from the group consisting of Mg, La, Ce, Pr, Nd, Eu, Ni, Co, and Pd is added to melted Al after the furnace is filled with an inert gas, such as Ar. The mixture is cast into a casting mold, thereby the melted and cast ingot of the Al alloy is manufactured.

The melted and cast ingot is heated to 380° C. to 450° C. for 1 to 3 hours, and then is hot-rolled. More preferably, the melted and cast ingot is heated to 410° C. to 450° C. for 1 hour to 2 hours, and then is hot-rolled. Furthermore, the hot-rolled ingot is subjected to a heat treatment for recrystallization under conditions of retention at 450° C. to 550° C. for 1 to 3 hours. Finally, the ingot is subjected to a mechanical working so as to be molded to target dimensions, and is used as a target for sputtering. More preferably, the melted and cast ingot is subjected to a heat treatment for recrystallization under conditions of retention at 480° C. to 520° C. for 1 to 2 hours and a mechanical working.

The component compositions of an Al alloy can be a component composition consisting of 0.5 to 15% by mass of Mg, a total amount of 0.5 to 10% by mass of one or more elements selected from the group consisting of La, Ce, Pr, Nd, and Eu, and the remainder composed of Al and inevitable impurities, a component composition consisting of 0.5 to 15% by mass of Mg, 0.5 to 10% by mass of Ce, a total amount of 2 to 9% by mass of one or two elements selected from the group consisting of Ni and Co, and the remainder composed of Al and inevitable impurities, and a component composition consisting of 0.5 to 15% by mass of Mg, 0.5 to 10% by mass of Ce, 4 to 15% by mass of Pd, and the remainder composed of Al and inevitable impurities. The Al alloy reflective electrode film is formed on a substrate under normal conditions by sputtering using the Al alloy as a target.

Next, the Al alloy reflective electrode film in the anode layer of a top emission type organic EL element of the present invention will be described using the examples.

### EXAMPLE 1

Examples of the first and second aspects of the present invention will be described.

Highly-pure Al having a purity of 99.99% by mass or more and Mg, La, Ce, Pr, Nd, Eu, Ni, Co, and Pd, all of which have a purity of 99.9% by mass or more, were used as raw materials.

Firstly, highly-pure Al having a purity of 99.99% by mass or more was melted under a vacuum in a high frequency vacuum melting furnace. Next, the furnace was filled with an Ar gas until the internal pressure of the furnace reached atmospheric pressure. Then, one or more of Mg, La, Ce, Pr, Nd, Eu, Ni, Co, and Pd were added to the melted Al. The mixture was cast in a graphite casting mold, thereby manufacturing an Al alloy ingot.

The obtained ingot was heated at 430° C. for 2 hours and then hot-rolled. Then, the hot-rolled ingot was subjected to a heat treatment for recrystallization under conditions of retention at 500° C. for 1 hour. Finally, the ingot was subjected to a mechanical working, thereby, manufacturing targets 1 to 20 had dimensions of 152.4 mm in diameter and 6 mm in thickness. The component compositions are shown in Table 1 (hereinafter referred to as the ‘present invention targets’).

For comparison, comparative example targets 1 to 10, for which the added alloy components were the same as for the present invention targets, but the contents were outside the ranges of the present invention, were manufactured under the same conditions as the manufacturing conditions of the present invention targets.

In addition, a related art example target 1 to 10 were manufactured under the same conditions as the manufacturing conditions of the present invention targets. The related art example 1 was made of a highly-pure Al having a purity of 99.99% by mass or more. The related art example targets 2 to 10 contain any of Nd, Ta, Nb, Mo, W, Ti, Si, B, and Ni in a range of 5 atom% or less, having alloy components described in PTL 1.

The component compositions of the comparative example targets 1 to 10 and the related art example targets 1 to 10 are shown in Table 2.

Reflective electrode films were manufactured by the following sputtering step using the present invention targets 1 to 20, the comparative example targets 1 to 10, and the related art example targets 1 to 10, of which component compositions are shown in Tables 1 and 2, as materials. Firstly, each of the targets was soldered to oxygen-free copper backing plates. Then, the backing plates with the targets were mounted on a direct current magnetron sputtering device. Next, the direct current magnetron sputtering device was exhausted to 5×10⁻⁵ Pa using a vacuum exhauster, and Ar gas was introduced so as to form a sputter gas pressure of 0.5 Pa. Then, a 100 W direct current sputter electric power was applied to the targets using a direct current power supply. With the procedure, plasma was generated between the targets and alkali-free glass substrates, which faced the targets and were arranged in parallel to the target at intervals 70 mm. Each of the alkali-free glass substrates had a length of 30 mm, a width of 30 mm, and a thickness of 0.7 mm. By generating the plasma between the targets and the alkali-free glass substrates, the present invention reflective electrode films 1 to 20, comparative example reflective electrode films 1 to 10, and related art example reflective electrode films 1 to 10, having a thickness of 100 nm, were manufactured.

The component composition of each of the reflective electrode films manufactured in the above manner was analyzed by inductively coupled plasma atomic emission spectroscopy (ICP-AES). As a result, it was confirmed that reflective electrode films having substantially the same component compositions as the component compositions of the targets shown in Table 1 or 2 were manufactured in all cases.

The following measurements and tests (a), (b), (c), (d), (e), and (f) were carried out on the present invention reflective electrode films 1 to 20, the comparative example reflective electrode films 1 to 10, and the related art example reflective electrode films 1 to 10, which were manufactured in the above manner and were 100 nm in thickness.

The measurement samples for (d) were manufactured in a different procedure.

(a) Test on the initial reflectivity of the Al alloy reflective electrode films

The reflectivity of each of the present invention reflective electrode films 1 to 20, the comparative example reflective electrode films 1 to 10, and the related art example reflective electrode films 1 to 10 were measured using the spectrometer for ultraviolet and visible region V-550, manufactured by JASCO Corp., immediately after the manufacturing. The reflectivity at a wavelength of 550 nm is shown in Tables 3 and 4.

(b) Measurement of the Specific Resistance

The present invention reflective electrode films 1 to 20, the comparative example reflective electrode films 1 to 10, and the related art example reflective electrode films 1 to 10 were subjected to a heat treatment in nitrogen at 250° C. for 30 minutes. The condition simulates the thermal history the films subjected to during the manufacturing process of the organic EL element. After the heat treatment, the specific resistances were measured using the Loresta GP MCP-T610, manufactured by Mitsubishi Chemical Analytech Co., Ltd., by the four probe method. The results are shown in Table 3 and 4.

(c) Measurement of the Average Surface Roughness

The present invention reflective electrode films 1 to 20, the comparative example reflective electrode films 1 to 10, and the related art example reflective electrode films 1 to 10 were subjected to a heat treatment in nitrogen at 250° C. for 30 minutes. The condition simulates the thermal history the films subjected to during the manufacturing process of the organic EL element. After the heat treatment, the average surface roughness was measured using the atomic force microscope SPA-400, manufactured by Seiko Instruments Inc., in an area of 1 μm×1 μm. The values of the average surface roughness are shown in Table 3 and 4.

(d) Measurement of the Contact Resistivity

The contact resistances of the present invention reflective electrode films 1 to 20, the comparative example reflective electrode films 1 to 10, and the related art example reflective electrode films 1 to 10, with an ITO as the hole injection film were measured in the following procedure by the transmission line model (TLM) method.

Firstly, an ITO target having a diameter of 152.4 mm and a thickness of 6 mm was mounted on a magnetron sputter. Then, alkali-free glass substrates were mounted on a substrate holder in a state in which the alkali-free glass substrate and a stainless mask sheet provided with 1 mm-wide and 30 mm-long slits were overlapped. Next, sputtering was carried out at a substrate temperature of 250° C., an Ar gas pressure of 0.5 Pa, and an injection electric power of direct current 150 W. As a result, ITO films having a width of 1 mm, a length of 30 mm, and a thickness of 200 nm were manufactured on the glass substrate.

Next, a stainless steel mask sheet having 9 slits each having a width of 1 mm and a length of 10 mm were disposed at 2 mm intervals was prepared. Then, the ITO film-attached glass substrate and the stainless steel mask were overlapped so that the longitudinal direction of the slits intersected with the longitudinal direction of the ITO film. Then, after setting them in the substrate holder, a 300 nm-thick Al alloy film was formed on the ITO film using the present invention targets 1 to 20, the comparative example targets 1 to 10, and the related art example targets 1 to 10 sequentially.

The laminate films of the Al alloy and the ITO manufactured in the procedure described above were subjected to a heat treatment in which the laminate films were retained in nitrogen at 250° C. for 30 minutes, thereby preparing specimens for the measurement of the contact resistivity.

Two electrodes were selected from the 9 electrodes made of the Al alloy film, the electrical resistances were measured for all of the combinations, the distances between the electrodes and the measured resistance values were plotted in a graph, and straight lines were drawn by the least squares method.

The contact resistivity ρc was obtained from ρc=Lt×Rc×W (wherein ‘W’ represents the width of the ITO film, and is 0.1 cm in this case) using each of the intercepts of the distances between the electrodes and the measured resistance values on the graph as −2Lt and 2Rc. The results are shown in Tables 3 and 4.

(e) Corrosion Resistance Test

The present invention reflective electrode films 1 to 20, the comparative example reflective electrode films 1 to 10, and the related art example reflective electrode films 1 to 10 were retained in a constant temperature and humidity vessel having a temperature of 80° C. and a relative humidity of 85% for 100 hours. Then, they were taken out, and the reflectivity was measured using the spectrometer for ultraviolet and visible region V-550, manufactured by JASCO Corp. The reflectivity at a wavelength of 550 nm is shown in Tables 3 and 4.

(f) Evaluation of the Flatness Retention Capacities

The present invention reflective electrode films 1 to 20, the comparative example reflective electrode films 1 to 10, and the related art example reflective electrode films 1 to 10 were retained in a constant temperature and humidity vessel having a temperature of 80° C. and a relative humidity of 85% for 100 hours. Then, they were taken out, and the average surface roughness of the films was measured using an atomic force microscope SPA-400, manufactured by Seiko Instruments Inc., in an area of 1 μm×1 μm. The values of the average surface roughness are shown in Table 3 and 4.

TABLE 1

| | | Component composition (% by mass) | | |
|---|---|---|---|---|
| | | | | Al and inevitable |
| Target | | Mg | Rare earth elements | impurities |
| Present invention | 1 | 1.0 | La: 7.0 | Remainder |
| | 2 | 4.0 | La: 3.0 | Remainder |
| | 3 | 11.0 | La: 1.5 | Remainder |
| | 4 | 0.6 | Ce: 9.5 | Remainder |
| | 5 | 1.5 | Ce: 2.0 | Remainder |
| | 6 | 3.0 | Ce: 3.0 | Remainder |
| | 7 | 5.0 | Ce: 1.0 | Remainder |
| | 8 | 14.5 | Ce: 1.5 | Remainder |
| | 9 | 2.0 | Pr: 3.0 | Remainder |
| | 10 | 7.0 | Pr: 6.0 | Remainder |
| | 11 | 13.0 | Pr: 1.0 | Remainder |
| | 12 | 1.0 | Nd: 4.0 | Remainder |
| | 13 | 4.5 | Nd: 2.0 | Remainder |
| | 14 | 12.0 | Nd: 0.6 | Remainder |
| | 15 | 0.8 | Eu: 3.0 | Remainder |
| | 16 | 4.5 | Eu: 4.0 | Remainder |
| | 17 | 10.0 | Eu: 1.0 | Remainder |
| | 18 | 1.5 | La: 1.0, Ce: 1.0 | Remainder |
| | 19 | 2.0 | Pr: 1.5, Nd: 1.5 | Remainder |
| | 20 | 1.5 | Ce: 4.0, Eu: 4.0 | Remainder |

TABLE 2

| | | Component composition (% by mass) | | |
|---|---|---|---|---|
| | | | | Al and |
| Target | | Mg | Rare earth elements | inevitable impurities |
| Comparative | 1 | 0.4* | La: 1.0 | Remainder |
| examples | 2 | 16.0* | Ce: 5.0 | Remainder |
| | 3 | 2.0 | La: 0.1* | Remainder |
| | 4 | 2.0 | Ce: 0.4* | Remainder |
| | 5 | 2.0 | Pr: 10.5* | Remainder |
| | 6 | 2.0 | Nd: 0.3* | Remainder |
| | 7 | 2.0 | Eu: 11.0* | Remainder |
| | 8 | 5.0 | Ce: 11.0* | Remainder |
| | 9 | 10.0 | Nd: 10.5* | Remainder |
| | 10 | 13.0 | Eu: 0.2* | Remainder |

| | Component composition (% by mass) | |
|---|---|---|
| Related art examples | 1 | Al |
| | 2 | Nd: 14.3 [3.0], remainder Al |
| | 3 | Ta: 6.3 [1.0], remainder Al |
| | 4 | Nd: 6.6 [2.0], remainder Al |
| | 5 | Mo: 3.5 [1.0], remainder Al |
| | 6 | W: 9.4 [1.5], remainder Al |
| | 7 | Ti: 7.7 [4.5], remainder Al |
| | 8 | Si: 4.2 [4.0], remainder Al |
| | 9 | B: 1.6 [1.5], remainder Al |
| | 10 | Ni: 4.3 [2.0], remainder Al |

(Note 1)
The mark ‘*’ in the comparative examples indicates values not satisfying the conditions for preparing the present invention targets.
(Note 2)
The numerals in [ ] in the related art examples indicates atom %.

TABLE 3

| | | Reflective electrode film characteristics | | | | | |
|---|---|---|---|---|---|---|---|
| | | | | | | Corrosion | Average |
| | | | | Average | | resistance | surface |
| | | | Specific | surface | Contact | (reflection | roughness |
| Repeller | | Initial | resistance | roughness | resistance | ratio after | after test |
| film | | reflectivity (%) | (μΩ · cm) | (nm) | (Ω · cm²) | test) (%) | (nm) |
| Present | 1 | 89.0 | 4.5 | 1.4 | 0.09 | 88.7 | 2.9 |
| invention | 2 | 90.4 | 4.3 | 1.0 | 0.08 | 89.8 | 3.1 |
| | 3 | 89.6 | 7.3 | 0.8 | 0.10 | 88.6 | 3.4 |
| | 4 | 88.2 | 4.5 | 1.3 | 0.13 | 87.7 | 2.9 |
| | 5 | 90.3 | 4.1 | 1.8 | 0.08 | 89.6 | 3.5 |
| | 6 | 90.7 | 4.2 | 1.4 | 0.07 | 89.9 | 3.3 |
| | 7 | 90.4 | 4.8 | 1.3 | 0.09 | 89.4 | 3.5 |
| | 8 | 89.5 | 7.9 | 0.7 | 0.11 | 88.8 | 3.1 |
| | 9 | 90.7 | 4.3 | 1.4 | 0.09 | 89.8 | 3.4 |
| | 10 | 89.8 | 5.8 | 0.9 | 0.12 | 89.0 | 3.0 |
| | 11 | 89.8 | 7.5 | 0.8 | 0.13 | 88.5 | 3.5 |
| | 12 | 90.5 | 4.2 | 1.7 | 0.08 | 89.2 | 3.3 |
| | 13 | 90.3 | 5.1 | 1.3 | 0.08 | 89.4 | 3.5 |
| | 14 | 89.9 | 6.9 | 0.8 | 0.19 | 88.3 | 3.7 |
| | 15 | 90.6 | 4.2 | 1.9 | 0.09 | 89.7 | 3.2 |
| | 16 | 90.4 | 4.9 | 1.3 | 0.10 | 89.3 | 3.1 |
| | 17 | 90.0 | 6.7 | 0.9 | 0.12 | 88.5 | 3.4 |
| | 18 | 90.4 | 4.3 | 1.8 | 0.09 | 89.5 | 3.5 |
| | 19 | 90.6 | 4.5 | 1.6 | 0.08 | 89.7 | 3.4 |
| | 20 | 88.5 | 4.3 | 1.4 | 0.11 | 88.0 | 2.9 |

TABLE 4

| | | Reflective electrode film characteristics | | | | | |
|---|---|---|---|---|---|---|---|
| | | | | | | Corrosion | Average |
| | | | | Average | | resistance | surface |
| | | | Specific | surface | Contact | (reflection | roughness |
| Repeller | | Initial | resistance | roughness | resistance | ratio after | after test |
| film | | reflectivity (%) | (μΩ · cm) | (nm) | (Ω · cm²) | test) (%) | (nm) |
| Comparative | 1 | 90.8 | 4.2 | 5.1 | 1.8 | 89.9 | 5.5 |
| examples | 2 | 89.3 | 13.3 | 0.8 | 0.17 | 88.3 | 3.8 |
| | 3 | 90.7 | 4.1 | 4.2 | 0.45 | 85.3 | 5.1 |
| | 4 | 90.7 | 4.2 | 3.0 | 0.33 | 86.2 | 4.8 |
| | 5 | 87.2 | 4.6 | 1.3 | 0.15 | 86.5 | 3.6 |
| | 6 | 90.5 | 4.1 | 3.8 | 0.41 | 86.7 | 5.3 |
| | 7 | 87.3 | 4.8 | 1.4 | 0.14 | 86.6 | 3.3 |
| | 8 | 87.1 | 6.7 | 1.2 | 0.13 | 86.4 | 3.2 |
| | 9 | 87.4 | 8.9 | 1.0 | 0.12 | 86.5 | 3.4 |
| | 10 | 89.2 | 7.3 | 2.6 | 0.46 | 85.5 | 4.5 |
| Related art | 1 | 90.7 | 4.1 | 7.2 | 16 | 83.0 | 7.6 |
| examples | 2 | 86.3 | 8.1 | 1.2 | 19 | 85.1 | 3.6 |
| | 3 | 89.8 | 6.5 | 1.3 | 11 | 88.8 | 3.4 |
| | 4 | 90.3 | 6.7 | 1.2 | 11 | 89.0 | 3.1 |
| | 5 | 90.2 | 6.8 | 1.4 | 13 | 89.3 | 3.7 |
| | 6 | 90.4 | 6.4 | 1.4 | 12 | 89.1 | 3.2 |
| | 7 | 88.7 | 11.1 | 1.8 | 18 | 88.1 | 3.4 |
| | 8 | 89.2 | 7.8 | 1.7 | 17 | 88.6 | 4.2 |
| | 9 | 90.2 | 6.5 | 1.8 | 13 | 86.7 | 5.0 |
| | 10 | 89.8 | 4.4 | 4.5 | 0.30 | 89.2 | 5.5 |

The results shown in Tables 1 to 4 show that the initial reflectivity, the specific resistance values, and the corrosion resistance of the present invention reflective electrode films 1 to 20 are not significantly different from those of the comparative example reflective electrode films 1 to 10 and the related art example reflective electrode films 1 to 10. On the other hand, the present invention reflective electrode films 1 to 20 show a low average surface roughness and low contact resistances with the hole injection layer compared to the comparative example reflective electrode films 1 to 10 and the related art example reflective electrode films 1 to 10. Therefore, with the reflective electrode films of the present invention, a variety of properties necessary for the reflective electrode film can be retained, and in addition, the occurrence of the non-illuminating spots (dark spots) can be suppressed. As a result, the lifetime of the top emission type organic EL element having the present invention reflective electrode film is longer than that of the related art reflective electrode film.

### EXAMPLE 2

Next, examples of the third and fourth aspects of the present invention will be described.

Highly-pure Al having a purity of 99.99% by mass or more and Mg, Ce, Ni, Co, and Pd, all of which have a purity of 99.9% by mass or more were used as raw materials.

Firstly, highly-pure Al having a purity of 99.99% by mass or more was melted under a vacuum in a high frequency vacuum melting furnace. Next, the furnace was filled with an Ar gas until the internal pressure of the furnace became the atmosphere. Then, one or more of Mg, Ce, Ni, Co, and Pd were added to the melted Al. The mixture was cast in a graphite casting mold, thereby manufacturing an Al alloy ingot.

The obtained ingot was heated at 550° C. for 2 hours, and then hot-rolled. Then, the hot-rolled ingot was subjected to a heat treatment for recrystallization under conditions of retention at 550° C. for 1 hour. Finally, the ingot was subjected to a mechanical working, thereby manufacturing targets 21 to 36 having a diameter of 152.4 mm and a thickness of 6 mm. Their component compositions are shown in Table 5 (hereinafter referred to as the ‘present invention targets’).

For comparison, comparative example targets 11 to 20 for which the added alloy components were the same as for the present invention targets, but the contents were outside the ranges of the present invention, were manufactured under the same conditions as the manufacturing conditions of the present invention targets. Although cracking occurred in the comparative example targets 12 and 14 during hot rolling, the cracked comparative example targets 12 and 14 were used as they were for preparing sample films for evaluation.

The component compositions of the comparative example targets 11 to 20 are shown in Table 6.

Reflective electrode films were manufactured by the following sputtering step using the present invention targets 21 to 36 and the comparative example targets 11 to 20, which are shown in Tables 5 and 6, as materials. Firstly, each of the targets was soldered to oxygen-free copper backing plates. Then, the backing plates with the targets were mounted on a direct current magnetron sputtering device. Next, the direct current magnetron sputtering device was exhausted to 5×10⁻⁵ Pa using a vacuum exhauster, Ar gas was introduced so as to form a sputter gas pressure of 0.5 Pa. Then, a 100 W direct current sputter electric power was applied to the targets using a direct current power supply. With the procedure, plasma was generated between the targets and alkali-free glass substrates, which faced the targets and were arranged in parallel to the target at intervals of 70 mm. Each of the alkali-free glass substrates had a length of 30 mm, a width of 30 mm, and a thickness of 0.7 mm. By generating the plasma between the targets and the alkali-free substrates, the present invention reflective electrode films 21 to 36 and comparative example reflective electrode films 11 to 20, which were 100 nm in thickness, were manufactured.

The component composition of each of the reflective electrode films manufactured in the above manner was analyzed by inductively coupled plasma atomic emission spectroscopy (ICP-AES). As a result, it was confirmed that reflective electrode films having substantially the same component compositions as the component compositions of the targets shown in Table 5 or 6 were manufactured in all cases.

The following measurements and tests (a), (b), (c), (d), (e), and (f) were carried out on the present invention reflective electrode films 21 to 36 and the comparative example reflective electrode films 11 to 20, which were manufactured in the above manner and had a thickness of 100 nm, in the same manner as in Example 1.

The measurement samples for (d) were manufactured in a separate procedure, similarly to in Example 1.

(a) Test on the initial reflectivity of the Al alloy reflective electrode films

(b) Measurement of specific resistance

(c) Measurement of average surface roughness

(d) Measurement of contact resistivity

(e) Corrosion resistance test

(f) Evaluation of flatness retention capacities

The measured values and the test results of the (a) to (f) are shown in Tables 7 and 8.

TABLE 5

| | | Component composition (% by mass) | | | |
|---|---|---|---|---|---|
| | | | | | Al and inevitable |
| Target | | Mg | Ce | Ni, Co, Pd | impurities |
| Present invention | 21 | 1.0 | 7.0 | Ni: 2.0 | Remainder |
| | 22 | 3.0 | 9.5 | Ni: 2.5 | Remainder |
| | 23 | 5.0 | 5.0 | Ni: 4.0 | Remainder |
| | 24 | 14.5 | 0.5 | Ni: 6.0 | Remainder |
| | 25 | 7.0 | 2.0 | Ni: 8.0 | Remainder |
| | 26 | 4.0 | 5.0 | Co: 2.5 | Remainder |
| | 27 | 14.0 | 2.5 | Co: 3.5 | Remainder |
| | 28 | 0.5 | 7.5 | Co: 5.0 | Remainder |
| | 29 | 1.5 | 9.0 | Co: 6.5 | Remainder |
| | 30 | 7.5 | 1.0 | Co: 8.5 | Remainder |
| | 31 | 5.0 | 4.0 | Ni: 2.0, Co: 2.0 | Remainder |
| | 32 | 0.5 | 7.0 | Pd: 4.0 | Remainder |
| | 33 | 4.0 | 9.0 | Pd: 7.0 | Remainder |
| | 34 | 3.0 | 8.0 | Pd: 10.0 | Remainder |
| | 35 | 14.0 | 5.0 | Pd: 12.0 | Remainder |
| | 36 | 7.0 | 0.5 | Pd: 14.0 | Remainder |

TABLE 6

| | | Component composition (% by mass) | | | |
|---|---|---|---|---|---|
| | | | | | Al and inevitable |
| Target | | Mg | Ce | Ni, Co, Pd | impurities |
| Comparative examples | 11 | 0.1* | 4.0 | Ni: 4.0 | Remainder |
| | 12 | 16.0* | 3.0 | Co: 5.0 | Remainder |
| | 13 | 4.0 | 0.3* | Ni: 5.0 | Remainder |
| | 14 | 5.0 | 11.0* | Co: 4.0 | Remainder |
| | 15 | 5.0 | 5.0 | Ni: 1.0* | Remainder |
| | 16 | 5.0 | 7.0 | Ni: 9.5* | Remainder |
| | 17 | 4.0 | 4.0 | Co: 1.0* | Remainder |
| | 18 | 4.0 | 5.0 | Co: 10.0* | Remainder |
| | 19 | 3.0 | 6.0 | Pd: 3.0* | Remainder |
| | 20 | 5.0 | 5.0 | Pd: 16.0* | Remainder |

(Note 1)
The mark ‘*’ in the comparative examples indicates values not satisfying the conditions for preparing the present invention targets.

TABLE 7

| | | Reflective electrode film characteristics | | | | | |
|---|---|---|---|---|---|---|---|
| | | | | | | Corrosion | Average |
| | | | | Average | | resistance | surface |
| Reflective | | | Specific | surface | Contact | (reflection | roughness |
| electrode | | Initial | resistance | roughness | resistance | ratio after | after test |
| film | | reflectivity (%) | (μΩ · cm) | (nm) | (Ω · cm²) | test) (%) | (nm) |
| Present | 21 | 87.7 | 13 | 0.3 | 0.08 | 87.6 | 0.4 |
| Invention | 22 | 83.1 | 25 | 0.3 | 0.11 | 82.9 | 0.3 |
| | 23 | 86.2 | 22 | 0.2 | 0.09 | 86.0 | 0.3 |
| | 24 | 82.0 | 27 | 0.2 | 0.12 | 81.7 | 0.4 |
| | 25 | 84.8 | 24 | 0.2 | 0.13 | 84.5 | 0.3 |
| | 26 | 86.8 | 18 | 0.3 | 0.10 | 86.5 | 0.4 |
| | 27 | 82.1 | 26 | 0.2 | 0.11 | 81.8 | 0.3 |
| | 28 | 86.1 | 19 | 0.3 | 0.08 | 85.9 | 0.3 |
| | 29 | 83.4 | 24 | 0.3 | 0.10 | 83.0 | 0.4 |
| | 30 | 85.0 | 21 | 0.2 | 0.12 | 84.7 | 0.3 |
| | 31 | 86.0 | 20 | 0.3 | 0.09 | 85.8 | 0.4 |
| | 32 | 86.5 | 17 | 0.3 | 0.08 | 86.4 | 0.4 |
| | 33 | 82.6 | 25 | 0.3 | 0.09 | 82.2 | 0.4 |
| | 34 | 84.9 | 22 | 0.2 | 0.10 | 84.6 | 0.3 |
| | 35 | 80.9 | 29 | 0.2 | 0.14 | 80.6 | 0.3 |
| | 36 | 84.5 | 23 | 0.2 | 0.14 | 84.1 | 0.4 |

TABLE 8

| | | Reflective electrode film characteristics | | | | | |
|---|---|---|---|---|---|---|---|
| | | | | | | Corrosion | Average |
| | | | | Average | | resistance | surface |
| Reflective | | | Specific | surface | Contact | (reflection | roughness |
| electrode | | Initial | resistance | roughness | resistance | ratio after | after test |
| film | | reflectivity (%) | (μΩ · cm) | (nm) | (Ω · cm²) | test) (%) | (nm) |
| Comparative | 11 | 88.6 | 9.5 | 3.9 | 2.1 | 88.4 | 3.9 |
| examples | 12 ** | 77.9 | 32 | 0.2 | 0.12 | 77.6 | 0.3 |
| | 13 | 85.6 | 11 | 2.8 | 0.13 | 83.0 | 3.5 |
| | 14 ** | 78.3 | 37 | 0.3 | 0.12 | 78.1 | 0.4 |
| | 15 | 88.0 | 6.2 | 1.0 | 0.11 | 86.3 | 2.9 |
| | 16 | 79.6 | 31 | 0.2 | 0.10 | 79.5 | 0.3 |
| | 17 | 88.4 | 5.8 | 1.1 | 0.10 | 86.9 | 3.5 |
| | 18 | 78.9 | 34 | 0.2 | 0.11 | 78.7 | 0.3 |
| | 19 | 88.6 | 5.6 | 1.0 | 0.09 | 86.4 | 3.6 |
| | 20 | 77.6 | 38 | 0.2 | 0.10 | 77.4 | 0.3 |

(Note 1)
For the ‘**’ in the comparative examples, cracking occurred in the targets, but film was formed with the cracked targets for preparing the film for evaluation.

The results shown in Tables 5 to 8 show that the present invention reflective electrode films 21 to 36 are satisfactory to be used as a reflective electrode film, although reflective electrode film they had a slightly low initial reflectivity and slightly high specific resistance compared to the related art example reflective electrode films 1 to 10. In addition, the present invention reflective electrode films 21 to 36 show a lower average surface roughness, low contact resistances with the hole injection layer, and even more superior flatness retention capabilities in comparison to the related art example reflective electrode films 1 to 10. Furthermore, the present invention reflective electrode films 21 to 36 show excellence in all of the initial reflectivity, the specific resistance values, the average surface roughness, the contact resistivity, and the flatness retention capabilities in comparison to the comparative example reflective electrode films 11 to 20. Therefore, with the present invention reflective electrode films 21 to 36, a variety of properties necessary for the reflective electrode film can be retained, and in addition, the occurrence of the not-illuminating spots (dark spots) can be suppressed. As a result, the lifetime of the top emission type organic EL element having the present invention reflective electrode film becomes longer than that of the related art reflective electrode film.

### INDUSTRIAL APPLICABILITY

The Al alloy reflective electrode film in the anode layer of the top emission type organic EL element of the present invention has a high reflectivity, a low specific resistance (high electric conductivity), and corrosion resistance. Furthermore, it shows a low average surface roughness and a low contact resistance. Therefore a longer lifetime of the reflective electrode film can be expected, and a wide range of applications to reflective films used for optical recording media, such as CDs and DVDs, or reflection type STN liquid crystal display apparatuses, reflective conductive films in organic EL display apparatuses, and the like, are possible.

1. An Al alloy reflective electrode film in an anode layer of a top emission type EL element having a component composition consisting of:
0.5 to 15% by mass of Mg;
a total amount of 0.5 to 10% by mass of one or more elements selected from the group consisting La, Ce, Pr, Nd, and Eu; and
a remainder composed of Al and inevitable impurities.

2. An Al alloy reflective electrode film in an anode layer of a top emission type EL element having a component composition consisting of:
1 to 5% by mass of Mg;
1 to 3% by mass of Ce; and
a remainder composed of Al and inevitable impurities.

3. An Al alloy reflective electrode film in an anode layer of a top emission type EL element having a component composition consisting of:
0.5 to 15% by mass of Mg;
0.5 to 10% by mass of Ce;
a total amount of 2 to 9% by mass of one or two elements selected from the group consisting Ni and Co; and
a remainder composed of Al and inevitable impurities.

4. An Al alloy reflective electrode film in an anode layer of a top emission type EL element having a component composition consisting of:
0.5 to 15% by mass of Mg;
0.5 to 10% by mass of Ce;
4 to 15% by mass of Pd; and
a remainder composed of Al and inevitable impurities.
